(19) United States
(12) Patent Application Publication
(10) Pub. No.: US 2013/0244091 A1
(43) Pub. Date: Sep. 19, 2013

(54) Battery Cell, Battery Cell Module, Method for Producing a Battery Cell Module and Motor Vehicle

(71) Applicants: Michael Gless, Stuttgart-Zuffenhausen (DE); Ralf Angerbauer, Moglingen (DE)

(72) Inventors: Michael Gless, Stuttgart-Zuffenhausen (DE); Ralf Angerbauer, Moglingen (DE)

(73) Assignee: Robert Bosch GmbH, Stuttgart (DE)

(21) Appl. No.: 13/819,689

(22) PCT Filed: Jul. 1, 2011
(86) PCT No.: PCT/EP2011/061096

§ 371 Date: May 12, 2013

(30) Foreign Application Priority Data
Aug. 31, 2010 (DE) 10 2010 039 979.5

(51) Int. Cl. H01M 2/30

(52) U.S. Cl. CPC H01M 2/30
USPC 429/179; 429/178; 29/623.1

(57) ABSTRACT

A lithium-ion battery cell includes a cell housing having a base area on which the battery cell is positioned, at least one side face, and two terminals. A first terminal is electrically conductively connected to a cathode of the battery cell, and a second terminal is electrically conductively connected to an anode of the battery cell. The terminals are arranged on at least one side face of the cell housing. A battery cell module includes a plurality of the battery cells. A terminal of a first battery cell makes contact with a terminal of a second battery cell. The disclosure describes a method for producing the battery cell module, in which at least one first and one second battery cell are provided, positioned next to one another, and at least one terminal of the first battery cell is electrically conductively connected to a terminal of the second battery cell.

The present invention relates to a battery cell, in particular a lithium-ion battery cell, which comprises a cell housing having a base area on which the battery cell is placed and at least one side face and also comprises two terminals, wherein a first terminal is electrically conductively connected to the cathode of the battery cell and a second terminal is electrically conductively connected to the anode of the battery cell.

The invention also comprises a battery cell module which comprises a plurality of battery cells according to the invention.

Further aspects of the present invention are a method for producing a battery cell module according to the invention, and also a motor vehicle which comprises at least one battery cell module according to the invention.

### PRIOR ART

A battery which comprises one or more galvanic battery cells is used as an electrochemical energy storage means and energy converter. When the battery or the respective battery cell is discharged, chemical energy which is stored in the battery is converted into electrical energy by intercalation. This electrical energy can therefore be requested by a user as required.

In hybrid and electric vehicles in particular, lithium-ion batteries or nickel-metal hydride batteries which comprise a large number of electrochemical cells which are connected in series are used in what are referred to as battery packs.

Conventional battery cells are configured in such a way that the two terminals, which are respectively connected to the cathode and anode, are arranged on an upper top face of the cuboidal housing of said battery cells. In order to produce a battery cell module or an entire battery which comprises a plurality of battery cells, these conventional battery cells are arranged in a relatively compact manner to form what is referred to as a battery pack. In order to realize an electrical circuit, preferably a series circuit, terminals of battery cells which are arranged next to one another are connected by means of cell connectors. These cell connectors can be extra components or else integral constituent parts of at least one terminal of a battery cell. In order to assemble battery cell modules, the individual battery cells therefore have to be positioned next to one another and fixed, and then the electrically conductive connection between the terminals has to be established by one or two terminals making contact with the cell connector. In other words, in addition to the assembly steps and assembly forces which are required to position and fix the battery cells, further assembly steps have to be carried out and further assembly forces have to be applied in order to establish the electrically conductive connection between the cell connection and at least one terminal. This increased expenditure on assembly is disadvantageous in respect of the required manufacturing time and the manufacturing devices which have to be provided, particularly in the case of large quantities.

### DISCLOSURE OF THE INVENTION

The invention provides a battery cell, in particular a lithium-ion battery cell, which comprises a cell housing having a base area on which the battery cell is placed and at least one side face and two terminals, wherein a first terminal is electrically conductively connected to the cathode of the battery cell and a second terminal is electrically conductively connected to the anode of the battery cell. According to the invention, the terminals are arranged on at least one side face of the cell housing. These side faces preferably extend perpendicular to the base area for the purpose of producing a cuboidal housing. However, the invention is not restricted to a cuboidal housing, but rather the housing could be designed in the form of a prism in a specific embodiment, with the result that the side face is arranged at an angle which differs from a right angle in relation to the base area. In a further alternative refinement, the cell housing is designed in a substantially cylindrical manner, with the result that the side face is formed by the cylindrical casing surface.

However, a battery cell which has a cuboidal housing is the preferred embodiment.

The battery cell according to the invention can also be a nickel-metal hydride battery cell.

### ADVANTAGES OF THE INVENTION

The advantage of the invention is, in particular, that a plurality of battery cells according to the invention can be positioned next to one another in such a way that the laterally arranged terminals make contact with one another and the battery cells are already connected to one another electrically in series or in parallel on account of their being positioned and fixed in a simple manner and with the lowest possible expenditure on assembly in this way. Customary clamping forces for fixing the battery cells, which are used in a housing for producing a battery cell module and/or for producing a complete battery for example, can therefore be used for applying the contact-making force between the terminals. In other words, clamping of the battery cells or the forces which produce this clamping can at the same time be used to establish electrically conductive contact with the terminals of the battery cells. The number of parts to be connected and, accordingly, also the required assembly steps for connecting the battery cells are reduced in comparison to conventional battery cells. Therefore, for example, no extra joining process for connecting an extra cell connector is required. As a result, the time required for assembly of a battery cell module having a plurality of battery cells can be considerably reduced. The transfer resistance is reduced on account of the low number of parts to be connected and also on account of the small distance between the battery poles of the individual battery cells, with the result that a module which comprises a plurality of battery cells according to the invention or a battery having a plurality of battery cells can be operated with a lower power loss and an improved overall degree of efficiency than conventional battery cell modules.

Provision is preferably made for the terminals to be arranged on side faces which are situated opposite one another. In other words, when the battery cell housing is designed in the form of a cuboid, a first terminal is arranged on a first side face, and a second terminal is arranged on a second side face, with the two said side faces being situated opposite one another. A series circuit comprising a plurality of battery cells according to the invention can be realized in a simple manner by virtue of the terminals being arranged in this way.

In a particular refinement, provision is made for a side face itself to be in the form of a terminal. In other words, the cell housing assumes the function of the terminal. In this refinement, the positive potential is preferably applied to the cell housing.

In a preferred refinement, the battery cell according to the invention has at least one elastically deformable element for realizing an elastically displaceable position of a contact area of a terminal. On account of this refinement, it is possible for a terminal of a first battery cell to apply a contact-pressure force on a terminal of a second battery cell, for example in order to produce a series circuit, when a plurality of battery cells are positioned sufficiently closely next to one another. A spring force which provides the elasticity ensures reliable contact-making and prevents mechanical overdetermination in respect of the positioning of the battery cell. In addition, in particular when clamping forces for fixing the battery cell are applied, overloading of the terminals which make contact with one another is avoided by means of the elasticity which is provided by the spring arrangement. Elasticity also has a positive effect in that manufacturing and/or assembly tolerances can be compensated for by said elasticity, with the result that less stringent requirements are made in respect of manufacturing and assembly.

In this case, the elastically deformable element can be a terminal. In other words, the terminal itself can form the elastically deformable element. In this case, the terminal can be designed as a block, with the elasticity being determined solely by the modulus of elasticity of the terminal material used. In an alternative refinement, the terminal is in the form of a spring element, for example in the form of a compression or bending spring, with said spring element preferably having a V shape when designed in the form of a bending spring. A first limb of the V shape is fixedly and electrically conductively connected to the respective battery pole and the other, second, limb forms the contact area of the terminal.

In another embodiment, provision is made for the elastically deformable element to be a side face of the battery cell housing on which a terminal is fixedly arranged or which itself forms the terminal. On account of the elastic deformation of the side face, the terminal which is fixedly arranged on the side face can be elastically displaced in respect of its position, with the result that it can exert an elastic pressure force on a terminal of another battery cell or on the contact area of said terminal when battery cells are arranged next to one another. In this case, forces which are applied in order to prevent operation-related expansion or “inflation” of the cell housing for the purpose of improving the performance and increasing the service life of the battery cell can be used in this refinement of the invention to apply the contact-making forces to the terminal.

A further refinement for realizing the elastically deformable element is a film or foil with which a side face is coated and on which a terminal is arranged, with the film or foil itself acting as a spring element.

In an alternative refinement, the elastically deformable elements are compression spring elements which elastically position at least one terminal of a battery cell.

In a further preferred refinement of the invention, provision is made for one terminal of the battery cell according to the invention to extend laterally beyond the plane of the respective side faces. In other words, the terminal projects out of the side face or laterally further from the center of the battery cell than it corresponds to the distance of the side face from the center of the battery cell. In this refinement, provision is made for the terminal to form the elastically deformable element and have a V shape, with the result that the contact area of said terminal projects over the side face.

In an alternative refinement, the terminal comprises a block, it being possible for the block to be fixedly connected to the battery cell pole or else to be provided as an extra component. In the latter refinement, said block has to be clamped in after the individual battery cells are positioned next to one another in order to realize the electrical contact between the battery poles or terminals of the battery cells, wherein the elastically deformable element applies the clamping force for fixing the block.

As already mentioned, in this case the elastic force and therefore the clamping force can be applied by the terminal itself and/or by a sprung side face. In other words, in the refinement with a block, said block itself is the elastically deformable element and/or a region of the other terminal, which region is used to support the block, and/or a side face on which the terminal is arranged, said terminal forming the elastically deformable element.

The terminal which projects over the side face is preferably arranged at the positive pole of the battery cell and is produced from a suitable aluminum alloy. However, refinements in which a terminal which extends laterally beyond the plane of the side face is connected to the negative pole of the battery cell should not be excluded from the invention.

The respectively other terminal of the battery cell according to the invention is preferably designed merely as a substantially smooth contact plane in the refinement in which a first terminal projects over a side face. In a particular embodiment, this contact plane can be made in the respective side face and therefore be at a shorter distance from the center of the battery cell than the side face on which said terminal is arranged. The advantage of this refinement is that, when a block is used on the first terminal, even with a decrease in the elastic effect of the elastically deformable element, said block is guaranteed to be fixed in an interlocking manner at least with two translatory degrees of freedom.

In addition, the invention provides a battery cell module which comprises a plurality of the battery cells according to the invention, wherein a terminal of a first battery cell makes contact with a terminal of a second battery cell. In this case, the terminal of the first battery cell according to the invention preferably makes direct contact with the terminal of the second battery cell according to the invention. In other words, the terminals rest one against the other in this preferred embodiment. This results in electrical contact being made without the aid of an extra connector.

A further aspect of the present invention is a method for producing a battery cell module according to the invention, in which method at least a first and a second battery cell according to the invention are provided, are positioned next to one another and at least one terminal of the first battery cell is electrically conductively connected to a terminal of the second battery cell. In this case, the terminals make contact by virtue of the contact areas of the terminals being pressed against one another, wherein this contact-pressing operation is realized by corresponding positioning of the battery cell, possibly with an elastically acting clamping force being applied, and/or by a spring behavior of at least one terminal and/or at least one side face on which a terminal is arranged.

In order to ensure electrical contact is made with the terminals over the long term, provision may also be made for a cohesive connection to be generated between the terminals. This cohesive connection is preferably established by means of a weld, in particular a laser weld. This laser welding process can be carried out in such a way that the terminals are connected to one another not only at their surface at an edge, but also by means of a deep weld.

The present invention also relates to a motor vehicle, in particular a motor vehicle which can be driven by an electric motor, which comprises at least one battery cell module according to the invention, wherein the battery cell module is connected to a drive system of the motor vehicle.

### DRAWINGS

Exemplary embodiments of the invention will be explained in greater detail with reference to the following description and the drawings, in which:

FIG. 1 shows a side view of a battery cell according to the invention,

FIG. 2 shows a top view of a battery cell module according to the invention with two battery cells according to the invention, and

FIG. 3 shows a side view of a first terminal 20 which is designed in the form of an elastically deformable element.

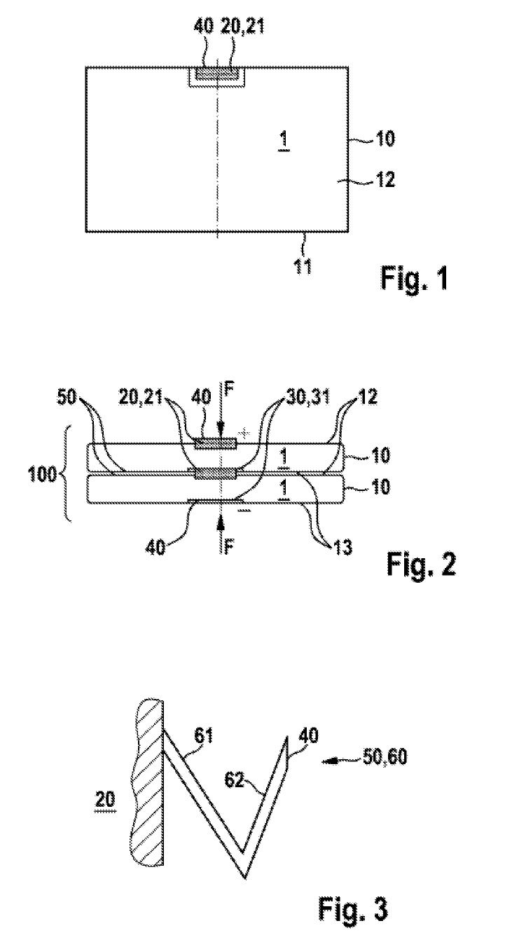

FIG. 1 shows a battery cell 1 which has a substantially cuboidal cell housing 10. Said cell housing 10 comprises a base area 11 which is arranged on the lower side and from which the first side face 12 and the second side face 13 extend in a substantially perpendicular direction, said first side face and second side face being arranged parallel to one another, as shown in FIG. 2 in particular.

FIG. 1 shows the first side face 12, and therefore the view illustrated in FIG. 1 corresponds to a view of the battery cell module 100 illustrated in FIG. 2 in the direction of the contact-pressure force F which is drawn from the top downward and acts on the positive pole.

A first terminal 20 is arranged on that first side face 12 which is illustrated in FIG. 1. This first terminal 20 has a contact area 40. In the embodiment which is illustrated in FIG. 1, the first terminal 20 comprises a block 21.

In other words, in contrast to conventional battery cells, on the battery cell 1 according to the invention, the terminals 20, 30 are not arranged on an upper boundary surface of the battery cell housing and so as to project out of it, but rather are arranged laterally on the cell housing 10.

This refinement makes it possible to connect a plurality of battery cells 1 in series in a simple manner in order to produce a battery cell module 100, as illustrated in FIG. 2 for example. Each of the battery cells 1 which are illustrated in FIG. 2 comprises a first terminal 20 and a second terminal 30. The first terminal 20 is preferably arranged on the positive pole of the battery cell 1 and the second terminal 30 is arranged on the negative pole of the battery cell 1. It can be seen that the respectively first terminal 20 comprises a block 21 which projects over the respective first side face 12. In contrast, the second terminal 30 is formed by a contact plane 31 which is made in the second side face 13. When the battery cells 1 are arranged next to one another and parallel to one another in the manner illustrated in FIG. 2, the respectively first terminal 20 presses on the respectively second terminal 30 of the adjacent battery cell 1. It is clear that electrical contact can therefore be established between the battery cells 1 as early as when the battery cells 1 are positioned and fixed next to one another. As a result, battery cell modules or else entire batteries, which comprise a plurality of battery cells, and also what are referred to as battery packs can therefore be generated in a simple manner and such that several assembly steps and several manufacturing devices are saved.

In this case, the invention is not restricted to the embodiment which is illustrated in FIG. 2 in which a distance is maintained between the battery cells 1, but rather the invention can also be designed in such a way that the side faces 13 and 12 rest directly one against the other.

In order to avoid mechanical overdetermination in respect of the positioning of the battery cells 1 and to prevent mechanical overloading of the terminals, in particular the first terminal 20 can be designed in the form of an elastically deformable element and/or at least one of the first side faces 12 or second side faces 13 can be designed in the form of an elastically deformable element in this case, with the result that the risk of damage to the cell housing 10 and/or to the terminals 20, 30 when the contact-pressure forces F are applied is prevent or reduced.

As an alternative or in addition to designing the terminals 20, 30 and/or the side faces 12, 13 in the form of elastically deformable elements, elastically deformable films or foils or spring elements can also be arranged between the battery cells 1. In one particular refinement, cooling elements, for example cooling plates, which at the same time have the desired elastic behavior can be arranged between the battery cells.

The invention is not restricted to the contact-pressure forces F being applied in the manner illustrated in FIG. 2 either, but rather it can be designed in such a way that the battery cells are positioned and fixed in the illustrated manner, wherein the contact-making forces which act on the terminals are applied solely only by elastically deformable elements of the battery cells, in particular by elastically deformable terminals. In other words, no clamping forces are used for realizing electrical contact-making in this refinement.

In an alternative refinement, it is also possible for the battery cells 1 to be designed without elastically deformable elements, wherein the battery cells 1 in FIG. 2 are positioned and are pressed against one another by means of the contact-pressure forces in such a way that the terminals 20, 30 make contact with one another.

However, one preferred embodiment of the battery cells according to the invention comprises a first terminal 20 which has an elastically deformable element 50, as is schematically shown in FIG. 3.

This elastically deformable element 50 comprises a spring element 60 which forms a first limb 61, which is fixedly connected to the respective battery pole, and a second limb 62 which has a contact area 40. The first limb 61 substantially forms a V shape together with the second limb 62. The illustrated elastically deformable element 50 makes elastic deformation possible in a simple manner, for example by bending in the region of the limbs 61, 62, with the result that said elastically deformable element 50 can realize a contact-making force between the contact area 40 of said elastically deformable element and a second terminal 30, as illustrated in FIG. 2 for example, in a simple manner. In other words, when the elastically deformable element 50 is provided instead of the block 21 in FIG. 2, the required contact-making force between the terminals 20, 30 is provided by the second terminal 20 or by the elasticity of said second terminal in a simple manner. In a refinement of this kind, the contact-pressure forces F which are illustrated in FIG. 2 do not necessarily have to be present, but rather the battery cells 1 can, as illustrated, be positioned and fixed at a specific distance from one another, wherein the contact-making force between the terminals 20, 30 is applied by the elastically deformable element 50.

1. A battery cell comprising:
a cell housing including (i) a base area on which the battery cell is placed, (ii) at least one side face, and (iii) two terminals, a first terminal of the two terminals is electrically conductively connected to a cathode of the battery cell and a second terminal of the two terminals is electrically conductively connected to an anode of the battery cell, and the two terminals are arranged on at least one side face of the cell housing.

2. The battery cell as claimed in claim 1, wherein the two terminals are arranged on side faces of the cell housing, which are situated opposite one another.

3. The battery cell as claimed in claim 1, wherein a side face of the cell housing is configured as a terminal.

4. The battery cell as claimed in claim 1, further comprising:
at least one elastically deformable element configured to realize an elastically displaceable position of a contact area of a terminal of the two terminals.

5. The battery cell as claimed in claim 4, wherein the elastically deformable element is configured as a terminal of the two terminals.

6. The battery cell as claimed in claim 4, wherein the elastically deformable element is configured as (i) a side face of the cell housing on which a terminal of the two terminals is fixedly arranged, or (ii) a terminal of the two terminals.

7. A battery cell module comprising:
a plurality of the battery cells, each battery cell of the plurality of battery cells including a cell housing having (i) a base area on which the battery cell is placed, (ii) at least one side face, and (iii) two terminals, a first terminal of the two terminals is electrically conductively connected to a cathode of the battery cell and a second terminal of the two terminals is electrically conductively connected to an anode of the battery cell, and the two terminals are arranged on at least one side face of the cell housing,
wherein a terminal of the two terminals of a first battery cell of the plurality of battery cells makes contact with a terminal of the two terminals of a second battery cell of the plurality of battery cells.

8. A method for producing a battery cell module, comprising:
providing at least a first battery cell and a second battery cell;
positioning the first battery cell and the second battery cell next to one another; and
electrically conductively connecting at least one terminal of the first battery cell to a terminal of the second battery cell,
wherein the first battery cell and the second battery cell each includes a cell housing having (i) a base area on which the battery cell is placed, (ii) at least one side face, and (iii) two terminals, a first terminal of the two terminals is electrically conductively connected to a cathode of the battery cell and a second terminal of the two terminals is electrically conductively connected to an anode of the battery cell, and the two terminals are arranged on at least one side face of the cell housing.

9. The method for producing a battery cell module as claimed in claim 8, further comprising:
generating a cohesive connection between the at least one terminal of the first battery cell and the terminal of the second battery cell.

10. The battery cell module as claimed in claim 7, wherein:
the battery cell module is included in a motor vehicle,
the motor vehicle includes a drive system,
the motor vehicle is configured to be driven by an electric motor, and
the battery cell module is connected to the drive system of the motor vehicle.
